(19) United States
(12) Patent Application Publication
(10) Pub. No.: US 2007/0168352 A1
(43) Pub. Date: Jul. 19, 2007

(54) Middleware scalability with distributed caching

(75) Inventor: Sudhir Krishna Satyanarayana, Bangalore (IN)

Correspondence Address: KENYON & KENYON LLP, 1500 K STREET N.W., WASHINGTON, DC, 20005, US

(73) Assignee: SAP AG, Walldorf (DE)

(21) Appl. No.: 11/523,499

(22) Filed: Sep. 20, 2006

(30) Foreign Application Priority Data
Dec. 30, 2005 (IN) 27/DEL/2006

(51) Int. Cl. G06F 17/30

(52) U.S. Cl. 707/10

(57) ABSTRACT

A system and method for locally storing data for multiple users to eliminate the need for the individual users to connect to a central server or servers. A communication session is opened between a data server and a remote station. Aggregated data is downloaded for a plurality of users from the data server to a local data store of the remote station via a network. The communication session is then closed. Thereafter, responsive to a device associated with a user of the plurality of users connecting to the remote station, data for the user, previously downloaded as a portion of the aggregated data from the data server, is downloaded from the remote station to the device.

### CROSS REFERENCE TO RELATED APPLICATIONS

This application claims foreign priority to Indian patent application No. 27/DEL/2006 dated Jan. 2, 2006, deemed to have been filed on Dec. 30, 2005, the entire contents of which are incorporated herein by reference.

### BACKGROUND

“Middleware” is a software platform aimed at enabling synchronization of data from backend systems on to remote devices (e.g., dial-up computer terminals; personal digital assistants (PDAs)). Middleware provides data consolidation from the backend, identifying what data needs to go to which users. Data is queued by the middleware. When a user comes online from a remote device, the middleware synchronizes with the remote device, downloading the queued data to the remote device.

In general, a “front-end” is a type of program or process that is responsible for collecting input from a user (e.g., a user interface), whereas a “backend” is a type of program or process that is responsible for processing the input from the front-end. A backend is not directly accessed by a user, and may carry out tasks independent of the front-end. For example, a user could request data from a database, not knowing that the data is refreshed on the backend on a daily basis. Among other responsibilities, a backend establishes virtual connections (sockets) between processes.

After synchronization between the middleware and a remote device, a user may go offline and perform various tasks. The next time the user comes online, the data is again synchronized between the remote device and the backend system through the middleware.

Middleware uses a queue or queues in order to enable fast synchronization. Until the user comes online the data remains queued. A synchronization module on the middleware and/or remote device extracts the data from the queue and synchronizes with the remote device. Such data might include sales orders, invoices, purchase approvals, etc. The devices can be located in different geographical regions connected by thin network connections (e.g., Wide Area Network (WAN) connections; Local Area Network (LAN) connections) affecting the performance of synchronization.

The time and financial costs of synchronizing data between the middleware and the remote devices of individual users in disparate geographical regions can be non-trivial. Moreover, network performance over such long distances can make such synchronization slow or unreliable.

### BRIEF DESCRIPTION OF THE DRAWINGS

FIG. 1 illustrates a block diagram of the system.

FIG. 2 illustrates transactions between the middleware, a communications station, and a plurality of remote devices.

FIG. 3 illustrates a transactions between the middleware, a communications station, and a remote device, during which the remote device is assigned to the communications station.

### DETAILED DESCRIPTION

Synchronization performance is improved by use of communication stations. The communication stations can be located in any geographical region connected by a thin network (WAN/LAN). These stations provide connection pooling and access to data in the middleware queue to the clients connecting to the station.

The communication station is enhanced with a local data store or cache where the data staged in the queues can be downloaded and locally stored. When the remote devices come online, the data is fetched from the local data store, and the synchronization is faster than it would be if a communication session had to be established directly with the middleware of a central system. For example, in geographic regions where long-distance communications are slow or erratic, being able to synchronize with a local data store accelerates performance.

Specifically, responsive to an opening of a communication session between a data server and a remote station over a network, aggregated data for a plurality of users is downloaded from the data server to a local data store of the remote station. After the communication session is closed, when a device associated with one of the users connects to the remote station, a portion of the aggregated data for the user is downloaded from the remote station to the device.

The data can either be pushed to the communication station from the middleware or the data can be pulled from the middleware by the communication station. In either case, communication sessions preferably occur at periodic intervals.

Among other advantages, remote communications stations permit data to be aggregated for multiple users and downloaded when the user devices are offline, while enabling the session to be scheduled at non-peak hours (e.g., when there are lower telecom costs or less network traffic). For example, if the communication station is in the United States and the middleware server is in Europe, the data can be downloaded to the communication station at night time of the United States when the network traffic is less and additionally when all the clients in the United States connect in the morning, they utilize only the local network providing fast and speedy synchronization. Downloading to the communication station also facilitates high data volumes at synchronization.

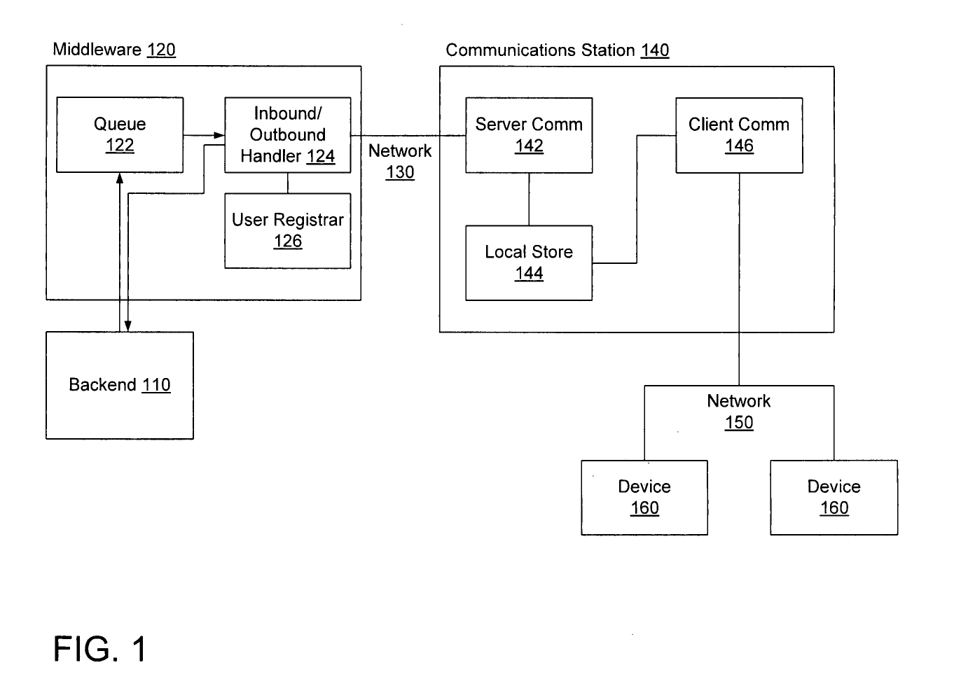

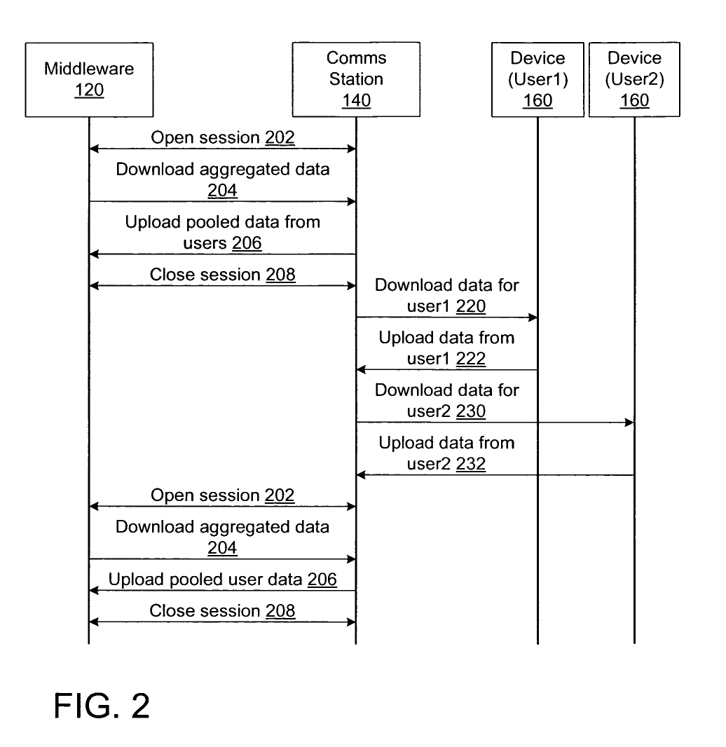

FIG. 1 illustrates an example system and FIG. 2 illustrates system transactions. The middleware 120 aggregates data from a backend system or systems 110 in a queue 122 (i.e., data storage memory) for a plurality of users. After a communications session is opened (202) between the middleware 120 and the communications station 140, the data in the queue is either pushed to the communications station 140 from the middleware 120 over the network 130 by the middleware, or pulled over the network 130 by the communication station 140 from the middleware 120. The communication session may be opened (202) by either the middleware 120 or the communications station 140. The opening of the communication session (202) may be periodically initiated, may be initiated based on the quantity of data filling the queue 122 and/or local store 144, and/or may be based upon the urgency of data held in the queue 122 and/or local store 144 (e.g., data flagged or identified as time-sensitive may cause a session to be opened at a non-scheduled time).

The middleware 120 may also initiate a session to a communications station 140 when the data queued for the communications station reaches a threshold based upon the capacity of the local store 144 of the communications station 140 (i.e., download before reaching a limit that would overflow the communication station 140).

A server communication handler 142 within the communications station 140 handles transactions with the middleware 120. Aggregated data received (204) from the middleware 120 is held in a local store 144.

After the communication session between the middleware 120 and the communications station 140 closes (208), if a remote device 160 connects to the communications station 140 via network 150, a client communication handler 146 downloads (220; 230) data from the local store 144 to the device 160. The client communication handler 146 also uploads (222; 232) any data on the device 160 intended for the middleware 120 and queues it in the local store 144. Pooled data uploaded from the devices 160 will be transmitted (206) to the middleware 120 during the next session between middleware 120 and the communication station 140.

Both the server communication handler 142 and the client communication handler 146 are inbound/outbound handlers, but preferably connect to separate channels. Specifically, network 130 and network 150 may be arranged as separate types of connections. For example, network 130 may be a dial-up connection, whereas network 150 may be a local area network (LAN).

The middleware 120 may either be standard middleware that has not been modified to manage communications stations, or modified middleware that has been optimized to manage communications stations.

If the middleware 120 is standard middleware, the inbound/outbound handler 124 handles transactions with the communications station as though it was the remote devices 160. The communications station 140 acts as a time-delayed proxy for the remote devices 160, simulating a connection with specific remote devices 160 during a session or sessions with the middleware 120. The middleware 120 does not distinguish between the communications station 140 and a direct connection with each of the devices 160. While this arrangement does improve connection flexibility by allowing the time selected for transactions between the middleware 120 and the communications station 140 to be optimized without any modification to an existing middleware platform, data pooling is not optimized. Specifically, since the middleware does not distinguish between a communication station 140 and a remote device 160, duplicate data needed on a plurality of remote devices 160 may be transmitted multiple times during a single session with the communications station 140.

Bandwidth utilization can be better optimized by modifying the middleware 120 to specifically recognize that a session is with a communications station 140, thereby facilitating data pooling. For example, if duplicate data is needed on a plurality of remote devices 160 associated with a particular communications station 140, it can be transmitted once during a session with the communications station 140 and then copied by the communications station as needed during individual sessions with the remote devices 160. This also facilitates using a smaller local store 144 in the communications station 140. The communications station 140 may use a unique site identifier which the middleware 120 associates with all of the users assigned to that station 140.

If duplicate data is downloaded only once for a plurality of users, the unique data to download to a specific user may include a pointer (e.g., a uniform resource identifier) mapped to where the shared data will be stored in the local store 144.

Once unique data is downloaded from the local store 144 to the device 160 for a user, the unique data may be flushed from the local store 144. Likewise, once data from a user held in the local store 144 is uploaded to the middleware 120, it may be flushed from the local store 144.

Several methods can be used to associate users with a particular communications station 140. Preferably, if data duplicate data mapping is being used to eliminate redundant downloads or data is being pushed by the middleware to the communications stations, which users are associated with which communications stations 140 may be centrally defined in the user registrar 126 of the middleware 120.

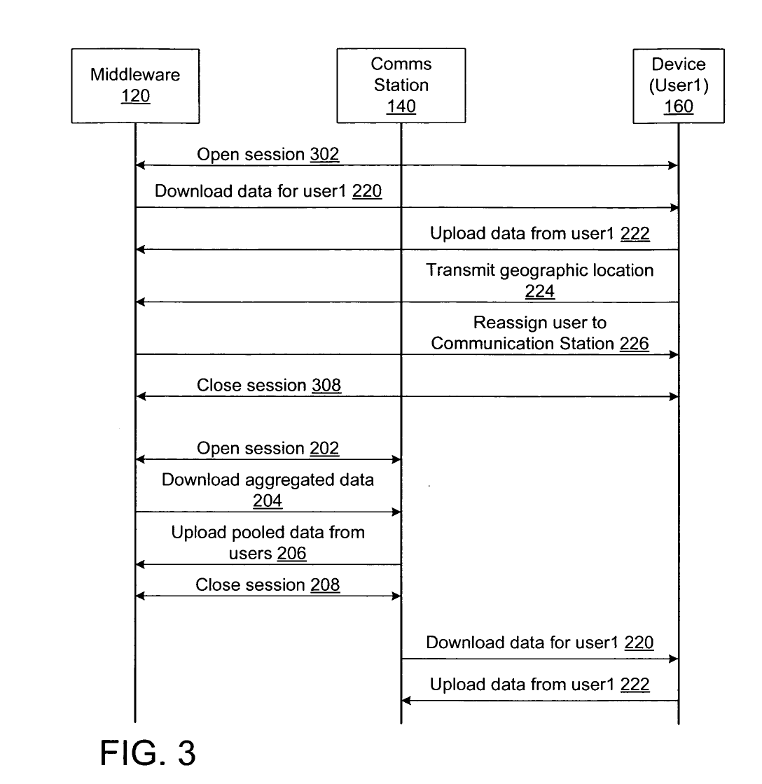

One example of how a user can become associated with a communications station 140 is illustrated in FIG. 3. The middleware 120 reassigns the user when the user connects. The user (from device 160) opens a communication session (302) directly with the middleware 120. The middleware 120 and the device 160 synchronize (220, 222). The device 160 transmits geographic information (224) to the middleware 120. A routine in the middleware compares the geographical region of the device 160, and checks to see if a communications station 140 is available for that region. If a communications station 140 is available, an instruction (226) is sent from the middleware 120 to the device 160 to contact the communication station 140 for future synchronizations. The communications session then closes (308). The data for that user is thereafter queued on the assigned communications station 140 in the device's region, and the user synchronizes with the communications station 140.

This same process can also be repeated if a device 160 synchronizes with a communications station 140 to check whether a better communications station is available (e.g., if the user has changed geographic regions or a new station 140 has been created closer to the user).

Another example of how a user can become associated with a communications station 140 consists of explicit registration, where the user enrolls with either the communications station 140 or the middleware 120 to synchronize data via a specific communications station 140.

The order of the various transactions may be different. For example, if the local store 144 on the communications station 140 is small, it may be advantageous to upload the pooled data from the users (206) from the communications station 140 to the middleware 120 before downloading the aggregated data (204) from the middleware 120 to the communications station 140.

The various components of the middleware 120 and/or the communications station 140 described herein may each be implemented as one or more processes on one or more computer systems. Each computer system may include a storage component for storing machine-readable instructions for performing the various processes described above. The storage component may be any type of machine readable medium (i.e., one capable of being read by a machine) such as a compact disk, hard drive memory, flash memory, floppy disk memory, DVD-ROM, CD-ROM or any type of machine readable (computer readable) storing medium. Each system or systems may also include addressable memory (e.g., random access memory, cache memory) to store data and/or sets of instructions that may be included within, or be generated by, the machine-readable instructions when they are executed by a processor on the respective system. The queue 122, local store 144, and user registrar 126 each include memory that may be selected from addressable memory (e.g., random access memory, cache memory) and a rewritable storage component (e.g., hard drive memory, flash memory, floppy disk memory).

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method comprising:
responsive to an opening of a communication session between a data server and a remote station over a network, downloading aggregated data for a plurality of users from the data server to a local data store of the remote station; and
after the communication session is closed, when a device associated with one of the users connects to the remote station, downloading a portion of the aggregated data for the user from the remote station to the device.

2. The method of claim 1, wherein the aggregated data downloaded for the plurality of users from the data server to the local data store includes both common data to be shared by two or more of the plurality of users and unique user-specific data, the common data being downloaded once per communication session.

3. The method of claim 1, wherein the opening of the communication session is initiated by the data server.

4. The method of claim 3, responsive to determining that at least some of the aggregated data is time sensitive, opening the communication session.

5. The method of claim 3, wherein the data server opens the communication session based upon a quantity of the aggregated data for downloading to the remote station reaching a threshold limit.

6. The method of claim 5, wherein the threshold limit is based upon a capacity of the local data store of the remote station.

7. The method of claim 1, wherein the opening of the communication session is initiated by the remote station.

8. The method of claim 1, further comprising associating each of the plurality of users with the remote station.

9. The method of claim 1, wherein the opening of the communication session is scheduled to occur periodically.

10. The method of claim 1, further comprising:
responsive to the device associated with the user of the plurality of users connecting to the remote station, uploading data from the device to the local data store of the remote station; and
during a next communication session between the data server and the remote station, uploading the data from the device held in the local data store to the data server.

11. The method of claim 10, wherein the opening of the communication session is initiated by the remote station.

12. The method of claim 11, wherein the remote station opens the communications session based upon a quantity of data held in the local store for uploading to the data server.

13. The method of claim 11, wherein responsive to determining that at least some of the data held in the local store for uploading is time sensitive, opening the communication session.

14. A machine-readable medium storing instructions adapted to be executed by a first computer to perform a method comprising:
downloading aggregated user-specific data for a plurality of users from a second computer during a communication session over a network;
after the communication session is closed, when a device associated with one of the users connects to the first computer, downloading a portion of the aggregated data for the user from the first computer to the device.

15. The machine-readable medium of claim 14, the method further comprising:
deleting said portion from the first computer after downloading the data to the device.

16. The machine-readable medium of claim 14, the method further comprising:
initiating an opening of the communication session with the second computer.

17. A machine-readable medium storing instructions adapted to be executed by a first computer to perform a method comprising:
simulating a first device of a first user during a communication session with a second computer to cause the second computer to download data queued for the first user to the first computer; and
after the communication session is closed, when the first device associated with the first user connects to the first computer, downloading the data for the first user from the first computer to the first device.

18. The machine-readable medium of claim 17, the method further comprising:
simulating a second device of a second user during the communication session with the second computer to cause the second computer to download data queued for the second user to the first computer; and
after the communication session is closed, when the second device associated with the second user connects to the first computer, downloading the data for the second user from the first computer to the second device.

19. A machine-readable medium storing instructions adapted to be executed by a data server to perform a method comprising:
queuing user-specific data for a plurality of users;
identifying which of the plurality of users are associated with a remote station;
aggregating the queued user-specific data for the plurality of users identified as being associated with the remote station; and
responsive to an opening of a communication session between the data server and the remote station over a network, downloading the aggregated data to the remote station.

20. The machine-readable medium of claim 19, wherein the data is aggregated to include only a single copy of common data that is queued for two or more of the plurality of users identified as being associated with the remote station.

21. The machine-readable medium of claim 19, the method further comprising:
deleting the aggregated data from the data server after downloading the data to the remote station.

22. The machine-readable medium of claim 19, the method further comprising:
initiating an opening of the communication session with the remote station.

23. A system comprising:
a middleware module on a data server to queue user-specific data in memory for delivery to one or more users; and
a remote station configured to download the queued user-specific data from the middleware module over a network to a local data store, and to transfer the user-specific data from the local data store to the respective user when a device of the user connects to the remote station to synchronize.

24. The system of claim 23, wherein the middleware module aggregates the queued user-specific data for users associated with the remote station, the queued user-specific data to be download to the remote station as aggregated data.

25. The system of claim 24, wherein the data is aggregated to include only a single copy of common data that is queued for two or more of the plurality of users associated with the remote station.

26. The system of claim 23, wherein when the remote station connects to the middleware module over the network, the remote station mimics individual devices of the respective users, causing the middleware module to download to the remote station the queued user-specific data for the user of each mimicked device.
